(19) United States
(12) Patent Application Publication
(10) Pub. No.: US 2025/0121430 A1
(43) Pub. Date: Apr. 17, 2025

(54) METHOD OF MANUFACTURING VEHICLE CHASSIS PARTS

(71) Applicants: HYUNDAI MOTOR COMPANY, Seoul (KR); KIA CORPORATION, Seoul (KR)

(72) Inventors: Cheol Ung Lee, Hwaseong-si (KR); Yoon Ki Lee, Suwon-si (KR); Ju Han Lee, Ulsan (KR)

(73) Assignees: HYUNDAI MOTOR COMPANY, Seoul (KR); KIA CORPORATION, Seoul (KR)

(21) Appl. No.: 18/777,893

(22) Filed: Jul. 19, 2024

(30) Foreign Application Priority Data
Oct. 11, 2023 (KR) 10-2023-0134894

(51) Int. Cl. B22D 19/04; B22D 19/00; B22D 21/00; B62D 65/00

(52) U.S. Cl. CPC B22D 19/045; B22D 19/0081; B62D 65/00; B22D 21/007

(57) ABSTRACT

A method of manufacturing a vehicle chassis part capable of increasing bonding strength between a cast material and an extruded material forming the chassis part is proposed. The method includes: forming a pattern portion for bonding to a cast material on an outer surface of an extruded material; inserting and fixing the extruded material into which the pattern portion is formed, in a mold for molding the cast material; and injecting molten metal for molding the cast material into the mold to form the cast material. A portion of the cast material overlaps the pattern portion of the extruded material to be formed integrally therewith.

### CROSS REFERENCE TO RELATED APPLICATION

This application claims priority to Korean Patent Application No. 10-2023-0134894, filed Oct. 11, 2023, the entire contents of which are incorporated herein for all purposes by reference.

### BACKGROUND

### Technical Field

The present disclosure relates to a method of manufacturing a vehicle chassis part. More particularly, the present disclosure relates to a method of manufacturing a vehicle chassis part to improve bonding strength between a cast material and an extruded material forming a chassis part.

### Description of the Related Art

Generally, a chassis part, such as a sub-frame, forming a chassis of a vehicle is manufactured through high-pressure casting, and a separate extruded material is welded and connected to a cast material to satisfy the required rigidity of a cast product manufactured through high-pressure casting.

FIG. 1 is a diagram illustrating a sub-frame including a cast material 1 and an extruded material 2 connected through welding.

In order to reduce defects caused by bubbles when welding the cast material and the extruded material in the chassis part such as the sub-frame, a high vacuum method is applied to minimize bubbles in a welded area.

However, due to a chronic bubble problem in a conventional high-pressure cast product, defects may inevitably occur in the welded area when welding the cast material and the extruded material due to the presence of the bubbles. This leads to a decrease in the bonding strength between the cast material and the extruded material and a decrease in the strength of the high-pressure cast product. Further, the decrease in the strength of the high-pressure cast product has a great influence on the impact characteristics of vehicles.

The statements in this BACKGROUND section merely provide background information related present disclosure and may not constitute prior art.

### SUMMARY

The present disclosure has been made keeping in mind the above problems occurring in the related art, and an objective of the present disclosure is to provide a method of manufacturing a vehicle chassis part. When forming the chassis part, this method increases bonding strength between a cast material and an extruded material that form the chassis part.

The objectives of the present disclosure are not limited to the above-mentioned objectives, and other objectives of the present disclosure that are not mentioned can be clearly understood by those having ordinary skill in the art from the following description.

In order to accomplish the above-described objective of the present disclosure, the present disclosure provides a method of manufacturing a vehicle chassis part. The method includes: forming a pattern (hereinafter “a pattern” or “a pattern portion”) on an outer surface of an extruded material. This pattern portion is used to firmly bond the extruded material and a cast material. The method further includes: inserting and fixing the extruded material into a mold configured to mold the cast material; and injecting molten metal for molding the cast material into the mold. A portion of the cast material may overlap the pattern portion of the extruded material to be formed integrally therewith. In other words, the portion of the casting material is integrally formed by overlapping with the pattern portion of the extrusion material.

The extruded material may be fixed by a sliding core provided in the mold, and thus the extruded material is not moved in the mold. The sliding core may have an insert portion that is inserted into and comes into a close contact with an end of the extruded material. The extruded material may form a hollow closed cross-section.

The pattern portion may include a plurality of grooves, and the plurality of grooves may have a predetermined depth, width, and interval.

The molten metal may be filled in the plurality of grooves provided in the pattern portion when the molten metal is injected into the mold.

The plurality of grooves may have a depth in a range of 100 μm to 200 μm, a width in a range of 100 μm to 300 μm, and an interval in a range of 100 μm to 300 μm.

Therefore, the present disclosure provides the following effects.

First, prior to insert injection molding, a pattern portion is previously formed in a predetermined portion of an extruded material overlapping a cast material, thereby significantly increasing the bonding strength between the cast material and the extruded material.

Second, the extruded material is fixed in a mold through a sliding core and then molten metal for molding a cast material is injected into the mold, thus scattering of the molten metal and molding defects can be avoided or prevented.

Third, the extruded material is fixed in a mold through a sliding core, so deformation of the extruded material due to casting pressure can be avoided or prevented.

The effects of the present disclosure are not limited to the above-mentioned effects, and other effects of the present disclosure that are not mentioned can be clearly understood by those having ordinary skill in the art from the following description.

### BRIEF DESCRIPTION OF THE DRAWINGS

The above and other objectives, features, and other advantages of the present disclosure should be more clearly understood from the following detailed description when taken conjointly with the accompanying drawings, in which:

FIG. 1 is diagram illustrating a cast product manufactured through conventional welding;

FIG. 2 is a perspective view illustrating a cast product manufactured by a manufacturing method according to an embodiment of the present disclosure;

FIG. 3 is a sectional view illustrating the cast product manufactured by the manufacturing method according to an embodiment of the present disclosure;

FIG. 4 is an enlarged view illustrating a pattern portion of an extruded material and a bonding area between a cast material and the extruded material manufactured by the manufacturing method according to an embodiment of the present disclosure;

FIG. 5 is a sectional view illustrating a mold for manufacturing a cast product according to an embodiment of the present disclosure;

FIG. 6 is a side view illustrating a sliding core of the mold according to an embodiment of the present disclosure; and

FIG. 7 is a flowchart illustrating a method of manufacturing a vehicle chassis part according to an embodiment of the present disclosure.

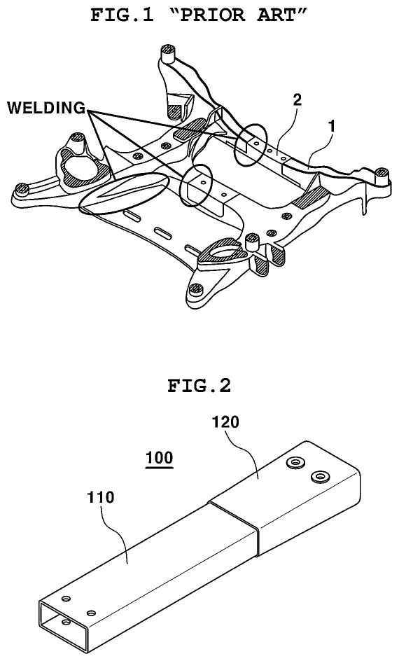

### DETAILED DESCRIPTION

Hereafter, embodiments of the present disclosure are described in detail with reference to the accompanying drawings. The drawings are intended to easily describe embodiments of the present disclosure, and the present disclosure may be embodied in many different forms.

It should be understood that, although the terms “first”, “second”, etc. may be used herein to describe various elements, these elements should not be limited by these terms. These terms are only used to distinguish one element from another element. For instance, a first element discussed below could be termed a second element without departing from the teachings of the present disclosure. Similarly, the second element could also be termed the first element. When a component, device, element, or the like of the present disclosure is described as having a purpose or performing an operation, function, or the like, the component, device, or element should be considered herein as being “configured to” meet that purpose or to perform that operation or function.

The present disclosure is directed to a method of manufacturing a chassis part for molding a cast material integrally with an extruded material while the separate extruded material is inserted into a casting mold during casting a vehicle chassis part.

Particularly, according to the present disclosure, in order to increase the bonding strength and coupling force between the extruded material and the cast material, a pattern portion is formed in advance in a predetermined portion of the extruded material through the surface treatment of the extruded material, and the cast material is molded to overlap the pattern portion of the extruded material.

Further, according to the present disclosure, in order to prevent the molten metal from scattering when molten metal for molding the cast material is injected into the mold, an end of the extruded material is immovably fixed and sealed in the mold, and then the molten metal is injected into the mold.

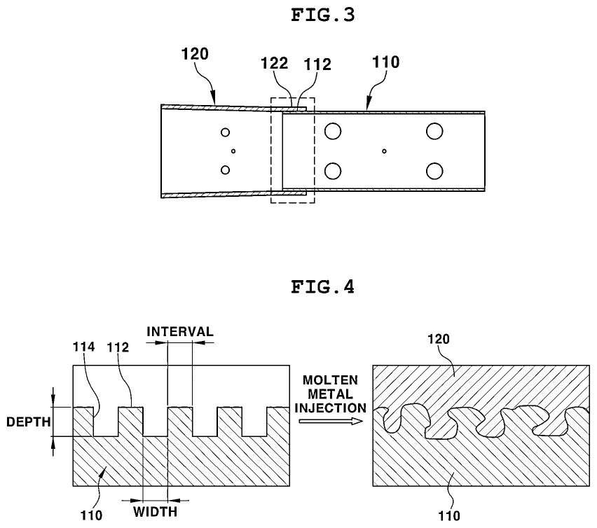

FIGS. 2 and 3 are a perspective view and a sectional view illustrating the cast product manufactured by the manufacturing method according to an embodiment of the present disclosure, and FIG. 4 is an enlarged view illustrating the pattern portion of the extruded material and a bonding area between the cast material and the extruded material formed by the manufacturing method according to an embodiment of the present disclosure.

Referring to FIGS. 2 to 4, a cast product 100 is manufactured through the manufacturing method according to an embodiment of the present disclosure. The cast product 100 includes an extruded material 110 having a pattern portion 112, and a cast material 120 that is cast to overlap the pattern portion 112 and thereby is formed integrally with the extruded material 110.

The cast material 120 has an overlapping portion 122 that is formed to overlap the pattern portion 112 of the extruded material 110. A vehicle chassis part according to the present disclosure may be formed of the cast product 100.

The pattern portion 112 is formed on an end of the extruded material 110 in a longitudinal direction thereof through surface treatment. The pattern portion 112 may be formed on an outer surface of the extruded material 110 through the surface treatment such as laser irradiation, etching, or anodizing.

The pattern portion 112 has a predetermined pattern to improve bonding strength between the cast material 120 and the extruded material 110. In other words, the pattern portion 112 has a plurality of grooves 114 in the form of depressions on the outer surface of the extruded material 110 to form a predetermined pattern. The plurality of grooves 114 have a predetermined depth and width and are arranged at a predetermined interval to increase the bonding strength between the cast material 120 and the extruded material 110.

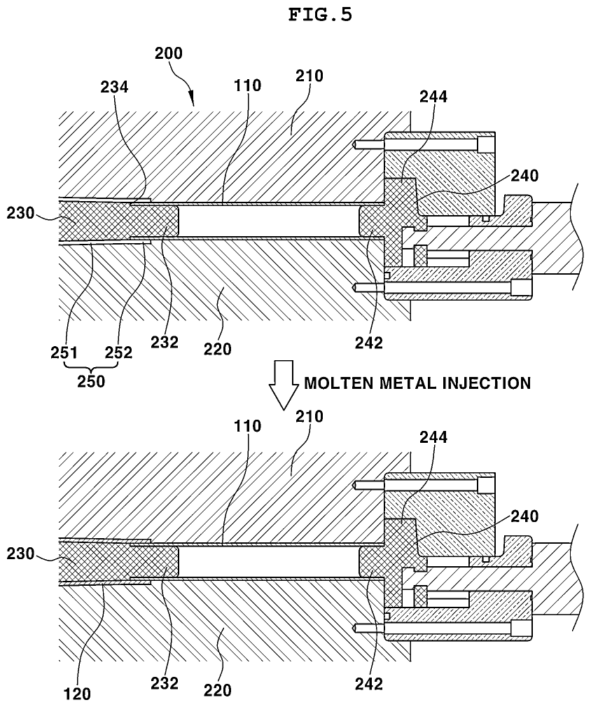

Referring to FIG. 4, the plurality of grooves 114 are filled with the molten metal when the molten metal for molding the cast material 120 is injected into a mold 200 (see FIG. 5). In this case, the molten metal fills the grooves 114 of the pattern portion 112 and partially melts the pattern portion 112, thereby increasing the bonding strength between the extruded material 110 and the cast material 120.

In one embodiment, the cast product 100 is manufactured through insert injection molding, so the bonding strength between the cast material 120 and the extruded material 110 that is an insert material is increased. In addition, the pattern portion 112 having the plurality of grooves 114 is formed in advance in the predetermined portion of the extruded material 110. The pattern portion 112 of the extruded material 110 overlaps the cast material 120, so the bonding strength between the extruded material 110 and the cast material 120 is further increased.

In particular, the plurality of grooves 114 may have different depths, widths, and intervals. For example, the plurality of grooves 114 may be formed to have the depth in a range of 100 μm to 200 μm, the width in a range of 100 μm to 300 μm, and the interval in a range of 100 μm to 300 μm. The plurality of grooves 114 may maximize the bonding strength between the extruded material 110 and the cast material 120 by having the above-mentioned range of depth, width, and interval. Particularly, when the plurality of grooves 114 have the depth of 200 μm, the width of 100 μm, and the interval of 100 μm, the bonding strength between the extruded material 110 and the cast material 120 may be maximized.

In one form, both the extruded material 110 and the cast material 120 may be molded and manufactured from aluminum alloy. To this end, molten metal obtained by melting aluminum alloy may be used.

The cast product 100 formed in this way may be cast using the mold 200 as shown in FIG. 5.

As shown in FIG. 5, the mold 200 includes a fixed die 210, a movable die 220 that moves linearly toward the fixed die 210, and a pair of sliding cores 230 and 240 that move linearly in a space between the fixed die 210 and the movable die 220.

The pair of sliding cores 230 and 240 is configured to enter the internal space of the mold 200 when the mold 200 is closed. The mold 200 is closed as the movable die 220 moves toward the fixed die 210.

In order to prevent the molten metal injected into the internal space of the mold 200 from scattering, the sliding cores 230 and 240 include insert portions 232 and 242 that may be inserted into the extruded material 110. The insert portions 232 and 242 each have a structure and sectional area that enable close contact with an inner surface of the extruded material 110 when inserted into the extruded material 110. The insert portions 232 and 242 are provided at ends of the sliding cores 230 and 240 in moving directions thereof.

The extruded material 110 forms a tubular metal structure, having a hollow closed cross-section. The extruded material 110 has a structure penetrating from one end to the other end in the longitudinal direction. As shown in FIG. 2, the extruded material 110 may have a rectangular closed cross-section.

The insert portions 232 and 242 of the sliding cores 230 and 240 may be inserted into ends of the extruded material 110 to close both ends of the extruded material 110, thereby preventing the molten metal injected into the mold 200 from scattering. Further, the insert portions 232 and 242 are inserted into and come into close a contact with the ends of the extruded material 110, thereby preventing the extruded material 110 from being deformed and damaged by the casting pressure for molding the cast material 120.

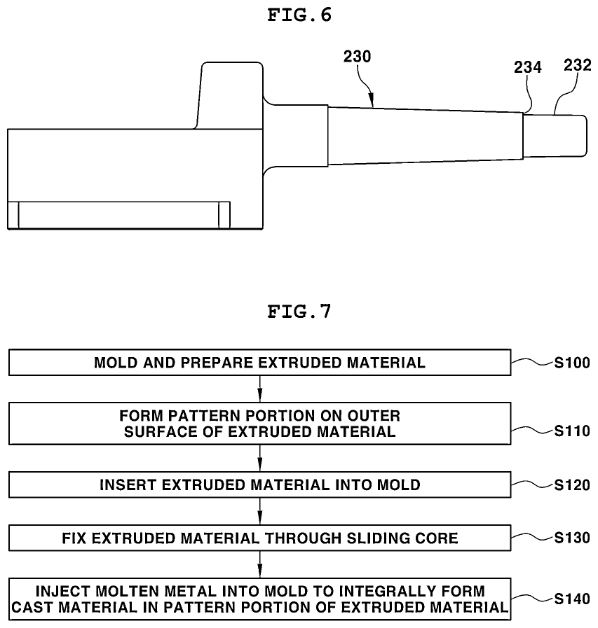

FIG. 6 is a side view illustrating the first sliding core 230 among the pair of sliding cores 230 and 240.

Referring to FIG. 6, the first sliding core 230 has a first stop end 234 adjacent to the first insert portion 232. The first stop end 234 is caught by one end (i.e. first end) of the extruded material 110 when the first insert portion 232 is inserted into the extruded material 110, thus preventing the first insert portion 232 from being further inserted.

Referring to FIG. 5, the second sliding core 240 also has a second stop end 244 adjacent to the second insert portion 242. The second stop end 244 is also caught by the other end (i.e., second end) of the extruded material 110 when the second insert portion 242 is inserted into the extruded material 110.

The internal space of the mold 200, which is selectively sealed when the mold 200 is closed, includes a cavity 250 for molding the cast material 120.

Referring to FIG. 5, the cavity 250 is a space surrounded by: i) the pattern portion 112 of the extruded material 110 inserted into the mold 200, ii) the first sliding core 230 that is inserted at the first insert portion 232 into one end of the extruded material 110, iii) the fixed die 210, and iv) the movable die 220. The cast material 120 may be molded by solidifying the molten metal injected and filled into the cavity 250.

In other words, the cavity 250 includes: a first space 251 between the mold 200 and the first sliding core 230, and a second space 252 between the mold 200 and the pattern portion 112 of the extruded material 110 inserted into the mold 200.

FIG. 7 is a flowchart illustrating a method of manufacturing the cast product 100.

Referring to FIG. 7, in an operation S100, the extruded material 110 is prepared by extrusion molding separately from the cast material 120. Here, the extruded material 110 is molded in the tubular structure having the hollow closed cross-section.

Next, in an operation S110, the pattern portion 112 is formed at one end of the extruded material 110 to overlap and be coupled to the cast material 120. The pattern portion 112 is formed on the outer surface of the extruded material 110 in advance before the extruded material 110 is inserted into the mold 200.

Thereafter, the movable die 220 is moved away from the fixed die 210 to open the mold 200. In an operation S120, the extruded material 110, in which the pattern portion 112 is formed, is inserted into the opened mold 200. In this case, the fixed die 210 may have a predetermined space into which the extruded material 110 is inserted and seated, and the extruded material 110 may be inserted into the predetermined space when the mold 200 is opened.

Subsequently, the movable die 220 is moved again toward the fixed die 210 to close the mold 200, and then the first sliding core 230 and the second sliding core 240 are moved toward the extruded material 110 within the mold 200. In this case, the first sliding core 230 and the second sliding core 240 are moved until the first insert portion 232 and the second insert portion 242 are completely inserted into both ends of the extruded material 110. As the first insert portion 232 and the second insert portion 242 are inserted into both ends of the extruded material 110 to come into a close contact therewith, the extruded material 110 is fixed so as not to be moved (in an operation S130).

After the extruded material 110 is fixed through the sliding cores 230 and 240, the molten metal for molding the cast material 120 is injected into the mold 200, thus forming the cast material 120 (in an operation S140). In this case, the molten metal is filled and solidified in the cavity 250 of the mold 200 to form the cast material 120. Further, the molten metal filled in the cavity 250 is also filled in the plurality of grooves 114 provided in the pattern portion 112 of the extruded material 110. As the molten metal is also filled and solidified in the grooves 114 of the pattern portion 112, the mechanical coupling force between the extruded material 110 and the cast material 120 is increased and the bonding strength therebetween is improved.

Since the cavity 250 includes the space 252 between the mold 200 and the pattern portion 112 of the extruded material 110 inserted into the mold 200, a portion of the cast material 120 overlaps the pattern portion 112 of the extruded material 110 to be formed integrally therewith. The portion of the cast material 120 is one end of the cast material 120 in the longitudinal direction thereof. The one end of the cast material 120 is the overlapping portion 122 that is integrally formed and joined to the pattern portion 112 of the extruded material 110.

The overlapping portion 122 is formed to have a closed sectional structure surrounding the pattern portion 112 in a circumferential direction. The cast material 120 including the overlapping portion 122 may be the tubular metal structure penetrating from one end to the other end, and may have an overall hollow closed cross-section.

The above-mentioned manufacturing method of the present disclosure can also be applied when manufacturing the vehicle chassis part.

Although the present disclosure was provided above in relation to specific embodiments shown in the drawings, it is apparent to those having ordinary skill in the art that the present disclosure may be changed and modified in various ways without departing from the scope of the present disclosure.

What is claimed is:

1. A method of manufacturing a vehicle chassis part, the method comprising:
forming a pattern portion on an outer surface of an extruded material;
inserting and fixing the extruded material into a mold configured to mold a cast material; and
injecting molten metal for molding the cast material into the mold to form the cast material,
wherein a portion of the cast material overlaps the pattern portion of the extruded material to be formed integrally therewith.

2. The method of claim 1, wherein the extruded material is fixed not to be moved in the mold by a sliding core provided in the mold.

3. The method of claim 2, further comprising: inserting an insert portion of the sliding core into an end of the extruded material such that the insert portion comes into a close contact with the end of the extruded material.

4. The method of claim 1, wherein the extruded material forms a hollow closed cross-section.

5. The method of claim 1, wherein the pattern portion comprises a plurality of grooves, and the plurality of grooves have a predetermined depth, width, and interval.

6. The method of claim 5, wherein the molten metal is filled in the plurality of grooves provided in the pattern portion when the molten metal is injected into the mold.

7. The method of claim 5, wherein the plurality of grooves have a depth in a range of 100 μm to 200 μm, a width in a range of 100 μm to 300 μm, and an interval in a range of 100 μm to 300 μm.
